(19) United States
(12) Patent Application Publication
(10) Pub. No.: US 2016/0022386 A1
(43) Pub. Date: Jan. 28, 2016

(54) A DENTAL IMPLANT

(71) Applicant: Azenium IP Limited, Katikati (NZ)

(72) Inventors: Simon P. McDonald, Katikati (NZ); Saraniyaa Sukumaar, Katikati (NZ); David Free, Katikati (NZ)

(73) Assignee: AZENIUM IP LIMITED, Katikati (NZ)

(21) Appl. No.: 14/775,199

(22) PCT Filed: Mar. 11, 2014
(86) PCT No.: PCT/US14/23804

§ 371 Date: Sep. 11, 2015

(30) Foreign Application Priority Data
Mar. 12, 2013 (NZ) 608130
Apr. 19, 2013 (NZ) 609632
Jul. 9, 2013 (NZ) 613034
Oct. 31, 2013 (NZ) 617267

(51) Int. Cl. A61C 8/00

(52) U.S. Cl. CPC A61C 8/0033; A61C 8/0068; A61C 8/0039; A61C 8/0019

(57) ABSTRACT

The present invention provides a dental implant that can be fitted immediately into a tooth socket after native tooth extraction and preparation of the tooth socket and without having to drill into the bone. The dental implant comprises a core enveloped by an expandable anchor comprising a plurality of joined segments. The core is displaced within an inner chamber of the anchor and generates an expansion force causing the joined segments to be displaced linearly away from the central axis of the implant where the coronal and apical ends of each joined segment are displaced in parallel paths normal to the central axis of the implant.

### FIELD OF THE INVENTION

This invention relates generally to the field of dentistry and more specifically to dental implants.

### BACKGROUND OF INVENTION

The field of prosthodontics deals with the replacement, rehabilitation and maintenance of clinical conditions associated with missing or deficient teeth. To replace a natural tooth, a dentist uses a variety of devices of which implant, abutment and crown are significant.

Majority of implants used now are made of titanium and are available in various sizes and shapes. A two-stage surgical protocol is used for the placement of a dental implant. Usually the first stage is the extraction of the tooth. Several months are required to allow new bone growth in the healing extraction socket. The second stage is when a hole is drilled into the bone and the implant is screwed in. It is also possible to place an implant directly into an extraction socket but this requires drilling deeper into the socket. Once the implant has osseointegrated into the bone, a permanent crown is placed. The entire procedure is time consuming, expensive, requires extensive technical skill, and is carried out over several visits to the dentist.

The above surgical implant procedure requires a level of skill and confidence that is beyond many general dentists. Primarily, many general dentists are anxious about drilling into bone and prefer to refer such patients to specialists. They are also concerned about the high cost of the surgical equipment required of relatively infrequent procedures.

The current invention aims to overcome several current problems faced during placing a dental implant. The object of this invention is to provide a dental implant that can be fitted immediately after tooth extraction. It is another object of the invention to enable placement of a dental implant without having to drill into the jaw bone. It is yet another object of this invention to allow for fast osseointegration directly around and into the placed implant. It is also the object of the invention to provide a kit of different sized and shaped dental implants that fits most tooth sockets.

### SUMMARY OF THE INVENTION

The present invention claims priority New Zealand Provisional Patent Application Nos. 608130 filed on Mar. 12, 2013, 609632 filed on Apr. 19, 2013, 613034 filed on Jul. 9, 2013, and 617267 filed on Oct. 31, 2013, the contents of which are incorporated herein by reference. The present inventive dental implant comprises the following aspects: (a) a core with a coronal end and an apical end; (b) an expandable anchor made of two or more individual, joined segments that define an inner chamber and envelopes at least a portion of the core, with the individual joined segments spreading apart as the core is displaced within the inner chamber of the anchor. The implant is transformable from a first, unexpanded position to a second, expanded position in response to an expansion force generated by the displacement of the core within the inner chamber of the anchor. The configuration of the joined segments of the expandable anchor enables the coronal and apical ends of each of the joined segments of the anchor to be horizontally displaced along parallel paths normal to the central axis of the implant. In one embodiment of the invention the core is apically displaced to generate and transfer the expansion force to the expandable anchor. In another embodiment the core is coronally displaced to generate and transfer the expansion force to the expandable anchor.

### BRIEF DESCRIPTION OF THE DRAWINGS

FIG. 1 is a perspective view of an embodiment of the present invention.

FIGS. 2A-2C are elevation views of components of the embodiment of the present invention shown in FIG. 1.

FIG. 3 is a perspective view of a component of the embodiment of the present invention shown in FIG. 1.

FIG. 4A is a bottom plan view of a component of the embodiment of the present invention shown in FIG. 1.

FIG. 4B is a top plan view of a component of the embodiment of the present invention shown in FIG. 1.

FIG. 5 is a perspective view of a component of the embodiment of the present invention shown in FIG. 1.

FIG. 6 is an elevation view of a component of the embodiment of the present invention shown in FIG. 1.

FIG. 7 is a top plan view of a component of the embodiment of the present invention shown in FIG. 1.

FIGS. 8-11 are perspective and partial sectional views of a component of the embodiment of the present invention shown in FIG. 1.

FIG. 12 is a cross-section view of a typical tooth socket.

FIG. 13 is an elevation view of another embodiment of the present invention.

FIGS. 14 and 15 are perspective views of a component of the embodiment of the present invention shown in FIG. 11.

FIGS. 16 and 17 are cross-section views taken along cross-section lines 16-16 and 17-17 of FIG. 13.

FIG. 18 is a perspective view of a component of the embodiment of the present invention shown in FIG. 13.

FIG. 19 is a top plan view of a component of the embodiment of the present invention shown in FIG. 13.

FIG. 20 is an elevation view of a component of the embodiment of the present invention shown in FIG. 13.

FIG. 21 is a perspective view of a component of the embodiment of the present invention shown in FIG. 13.

FIGS. 22-24 are perspective and partial sectional views of a component of the embodiment of the present invention shown in FIG. 13.

FIG. 25 is an elevation view of another embodiment of the present invention.

FIG. 26 is perspective view of a component of the embodiment of the present invention show in FIG. 25.

FIG. 27 is a perspective view of another embodiment of the present invention.

FIGS. 28 and 29 are perspective views of components of the embodiment of the present invention shown in FIG. 27.

### DETAILED DESCRIPTION OF THE DRAWINGS

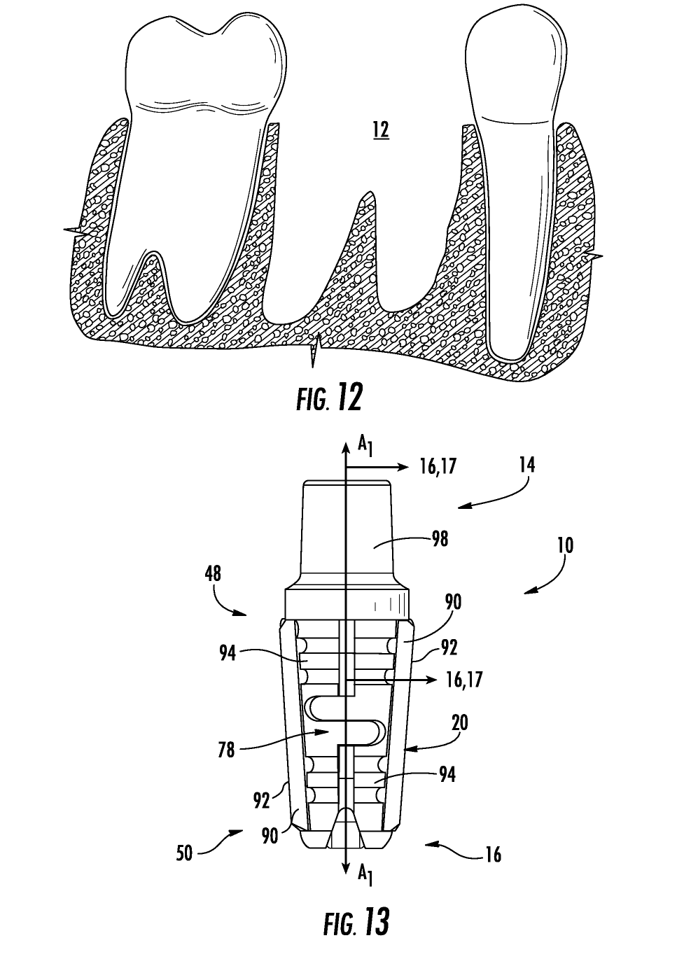

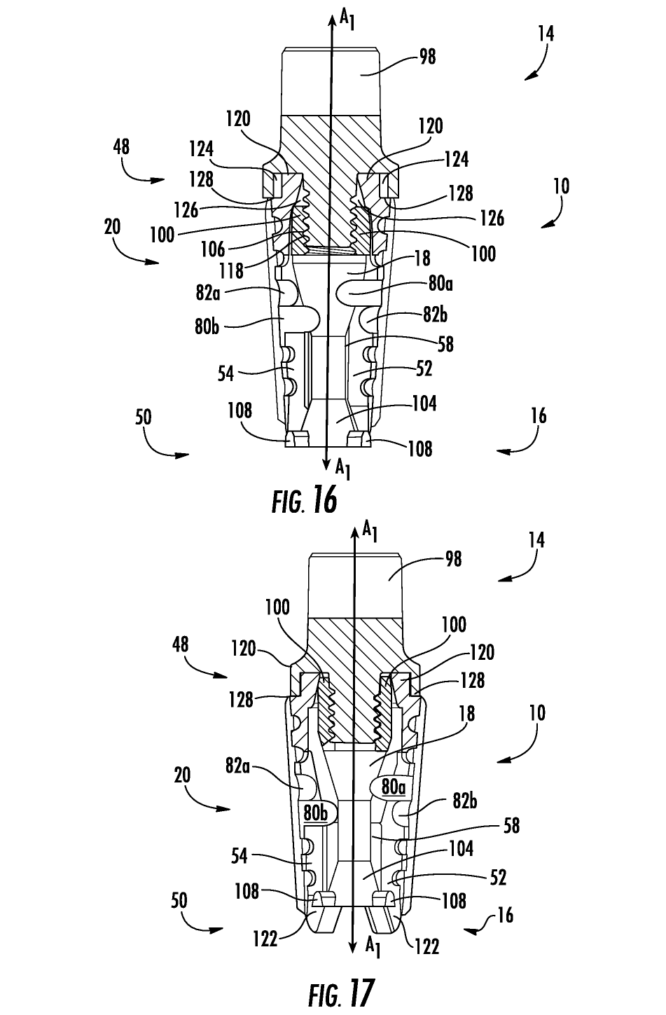

The attached FIGS. 1-33 show various embodiments of the present inventive dental implant 10 for secure placement into a tooth socket 12 (FIG. 12). Whenever possible, the same reference numbers are used in multiple figures to identify common elements. As seen in the attached figures, the present inventive dental implant 10, across all of the disclosed embodiments, includes a coronal end 14, apical end 16, a central axis A1 extending from the coronal end to the apical end, and consists of two main components, a core 18 and expandable anchor 20 that envelopes at least a portion of the core 18. In operation, the dental device 10 functions by displacing the core 18 in an inner chamber 58 of the anchor 20 along the central axis A1 to generate an expansion force causing individual, joined segments of the anchor to expand in a plane normal to the central axis A1, securing the dental implant 10 into the tooth socket 12. The joined segments of the anchor 20 each include a coronal end and apical end and the coronal and apical ends displace in parallel, linear paths normal to the central axis A1 in response to the expansion force. The components of the dental implant 10 are made of biocompatible material such as metal, ceramic or suitable plastic.

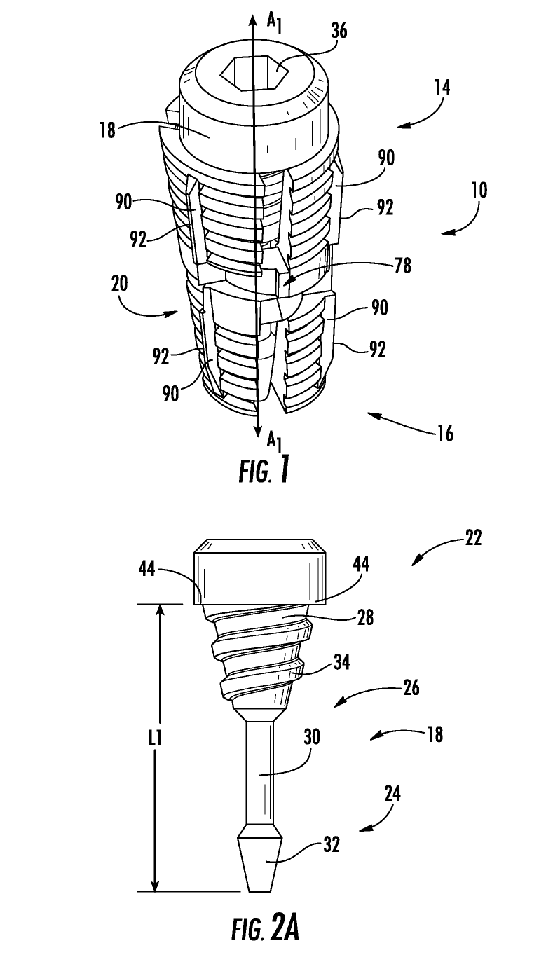

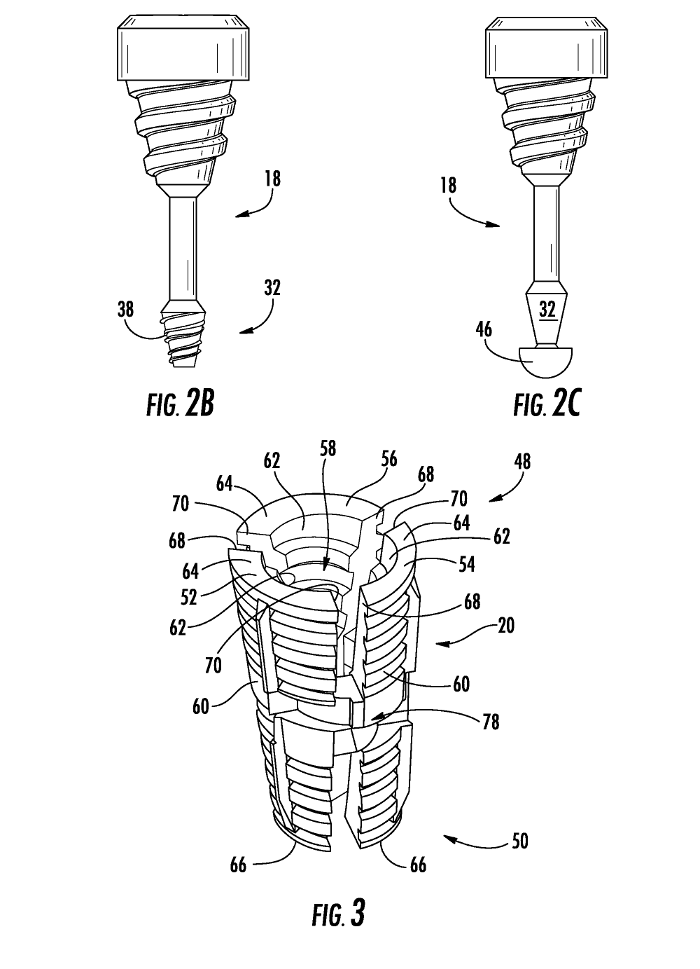

A first embodiment of the present invention is shown in FIGS. 1-11. Turning to FIG. 2, the core 18 consists of a coronal end 22, apical end 24, and a body member 26 extending between the coronal and apical ends 22, 24 and having a length L1 along the central axis A1 of the dental implant 10. The body member 26 generally tapers as it extends from the core coronal end 22 towards the core apical end 24. Accordingly, at least a portion of the length L of the body member 26 consists of a tapered section. In FIG. 2A, the body member 26 consists of a first and second frusto-conical, tapered section 28, 32 and a non-conical section 30 between the first and second tapered sections 28, 32. At least one of the tapered sections 28 includes a first helical thread 34 that begins at the core coronal end 22 and extends apically at least a portion of the section 28 and body member 26 towards the core apical end 24. In this FIG. 2, the angle of taper of the first and second tapered sections 28, 32 is the same. However, the first and second tapered sections 28, 32 may have different angles of taper and achieve the desired functionality. Likewise, in this FIG. 2A, only the first tapered section 28 includes the helical thread 34. However, as shown in FIG. 2B, the second tapered section 32 may also include a helical thread 38.

The core coronal end 22 further consists of a receptacle 36 which may receive a dental prosthesis, abutment, dental crown or healing cap, or, as seen in FIG. 1, is configured to receive a socket wrench or other suitable tool to rotate the core 18 during operation of the dental implant 10. The core coronal end 22 may also consist of a circumferential lip or rim 44 with a diameter that is greater than the largest diameter of the anchor 20 at its coronal end 48. In this configuration, the lip or rim 44 restricts the continued progression of the core 18 into the inner chamber 60 of the anchor 20, as described in greater detail below. The core apical end 24 may, optionally, terminate at a stop member 46 which, (as shown in FIG. 33), is shown as a hemispherical ball. In other embodiments, the stop member 46 is a cylindrical member or disk. The stop member 46 is design to allow fast osseointegration of the dental implant 10 into the surrounding bone of the tooth socket 12.

Turning to FIG. 3, the expandable anchor 20 has a coronal end 48, an apical end 50 and consists of a plurality of individual, joined segments 52, 54, 56 that form an inner chamber 58 configured to receive and envelope at least a portion of the core body member 26 (FIG. 2A). Each of the plurality of joined segments 52, 54, 56 includes outer and inner surfaces 60, 62, a top surface 64 at the coronal end 48, a bottom 66 at the apical end 50, and opposing side surfaces 68, 70. The top surface and bottom 64, 66 are generally curved or arced in their cross section and configuration and the outer and inner surfaces 60, 62, following the general curvature of the top and bottoms 64, 66, are generally curved or wrapped trapezoidal (see FIG. 5, 6). In this configuration the segments 52, 54, 56, when joined together, will exhibit an overall taper from the coronal end 48 towards the apical end 50 along the central axis A1 of the dental implant 10.

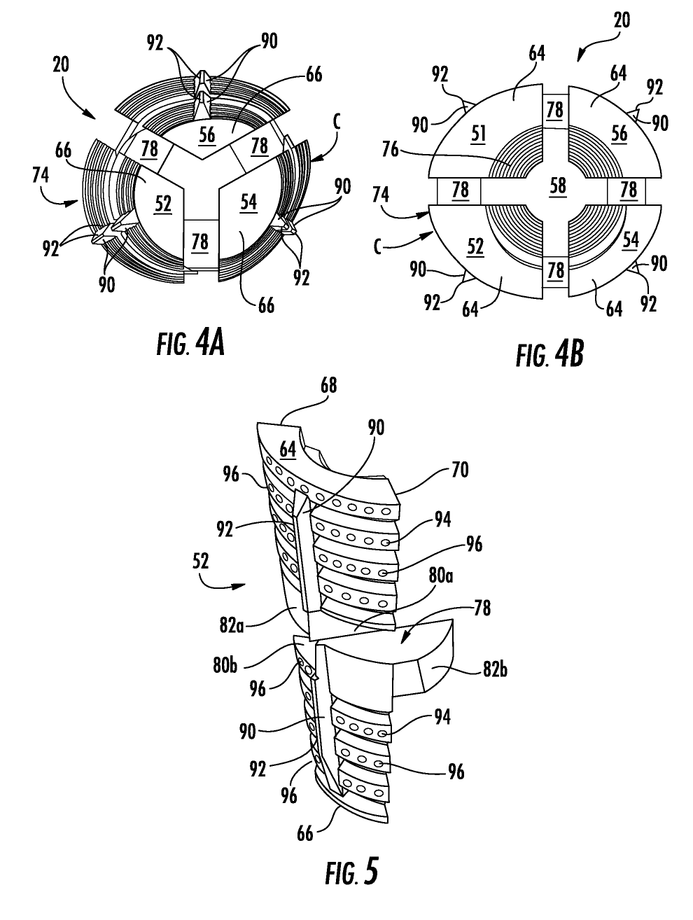

The inner chamber 58 is defined by the inner surfaces 62 of the joined segments 52, 54, 56 and is generally conical in shape with a circular inner form 76 and with a taper that matches the overall taper of the core body section 26. A second helical thread 72 on the inner surfaces 62 of the joined segments 52, 54, 56 corresponds with the first helical thread 32 of the core body member 26 and enables the core 18 to threadedly engage the anchor 20. The outer form 74 (FIGS. 3 and 4A) of the joined segments 52, 54, 56 of the anchor 20 has a circumference C and configuration similar to that of the tooth socket 12, which may be oval or egg-shaped or other shapes as determined by the patient's anatomy.

FIG. 4B shows an embodiment of the present invention, in a top plan view, in which the anchor 20 includes a first 51, second 52, third 54, and fourth 56 joined segment. The plurality of joined segments 51, 52, 54, 56 form an asymmetric outer form 74 having a circumference C. The inner chamber 58 has a circular inner form 76 that is eccentric with the outer form 76. To establish the asymmetry of the outer form 74, each of the joined segments 51, 52, 54, 56 has a varying thickness/cross-section area at each top surface 64. This configuration may be utilized regardless of the total number of joined segments forming the anchor 20.

The individual joined segments 52, 54, 56 of the expandable anchor 20 are joined together with connectors 78 in a manner to facilitate expansion of the individual joined segments 52, 54, 56 in a plane that is normal to the central axis A1 during operation of the dental implant 10. As seen in FIGS. 5-7, the joined segments 52 consists of a paired arm 80a, 80b and groove 82a, 82b assembly on each side surface 68, 70. Reference to the joined segment 52 is exemplary and joined segments 54, 56 incorporate the same features and configuration unless specifically noted herein. The arms 80a, 80b extend into and are received by a corresponding groove 82a, 82b on an adjacent joined segment. The joined segments 52, 54, 56 are held in place and guided during expansion of the dental device 10 by these arm 80 and groove 82 assemblies,

The arms 80a, 80b provide for restrictive movement of the adjacent joined segments 52, 54 or 54, 56, or 56, 52, thereby enabling the segments to move in one direction only, namely, radially in a plane normal to the central axis A1. The arms 80a, 80b protrude out of the joined segment 52 tangentially to the radius R1 of the inner surface 62 of the joined segment 52. The arms 80a, 80b may be of any shape but the corresponding grooves 82a, 82b have a similar shape to allow for the arms 80a, 80b. The arms 80a, 80b fit tightly into their corresponding grooves 82a, 82b with a friction fit.

Each of the joined segments 52, 54, 56 includes a first and second arm and groove assembly at different heights on the segment and with the arm and groove from each assembly arranged in a staggered configuration, e.g. each side surface 68, 70 including a single arm 80a, 80b and a single groove 82a, 82b. In the top plan view of FIG. 7, the arms 80a, 80b are wedge shaped with a straight or flat inner profile 84 and generally curved outer profile 86.

The outer surfaces 60 of each of the joined segments 52, 54, 56 of the anchor 20 may also include a rotational restrictor device consisting of an outwardly extending, vertical blade 90. The blade 90 extends over the majority of the length of each joined segment 52, 54, or 56 and consists of an acute-angled cutting edge 92 for securing the dental implant 10 in the tooth socket 12 against rotation about the central axis 12. The outer surface 60 of a joined segment 52, 54, or 56 of the anchor 20 may also include a vertical displacement restrictor consisting of at least a first horizontal ridge 94 that is substantially perpendicular to the blade 90 and extends across the width of the outer surface 60 of a joined segment. In the embodiments shown herein, the vertical displacement restrictor consists of a plurality of horizontal ridges 94.

The plurality of horizontal ridges 94 protrude outwardly from the outer surface 60 but have a depth that is less than the depth of the blade 90. Thus, the vertical blades 90 on the joined segments 52, 54, or 56 of the anchor 20 will engage the tooth socket 12 first to restrict rotational movement of the dental implant 10 during the initial insertion and placement within the tooth socket 12. As the anchor 20 expands during operation of the dental implant 10, the ridges 94 on the joined segments 52, 54, or 56 of the anchor 20 will subsequently engage the tooth socket 12 to restrict vertical displacement of the implant 10 within the tooth socket 12. A plurality of bone in-growth holes or bores 96 (FIG. 5) is disposed on the outer surface 60 of the joined segments 52, 54, or 56 and extends through each joined segment to the inner surfaces 62. The arrangement of the blades 90, ridges 94, and bone in-growth holes 96 on each of the joined segments allows for better osseointegration of bone as they provide a path for bone growth.

Dental implants 10 of various sizes and configurations according to the present invention, along with trial models, may be prepared and provided in kits to fit most tooth sockets and to enable the dentist or dental professional to select an implant that best fits the patient chair-side.

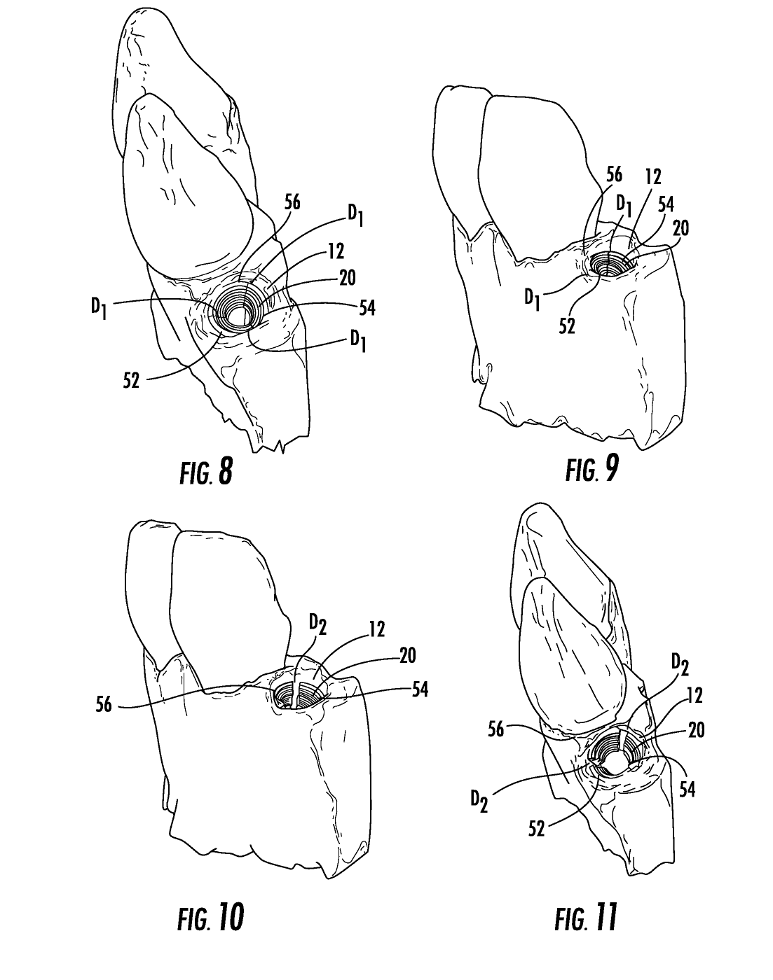

In operation, the joined segments 52, 54, 56 of the anchor 20 fit over the core 18 and under the circumferential lip 44 at the core coronal end 22. The process of threading the core 18 into the expandable anchor 20 expands the joined segments 52, 54, 56 of the anchor 20 in a plane that is normal to the central axis A1 to secure the dental implant 10 in place within the tooth socket 12. The expandable anchor 20 is transformable from a first, unexpanded position (FIGS. 8 and 9) wherein opposing side surfaces 68, 70 of adjacent segments 52, 54 or 54, 56 or 56, 52 are radially spaced apart at a first distance D1 and a second, expanded position (FIGS. 1, 10 and 11) where opposing side surfaces 68, 70 of adjacent segments 52, 54 or 54, 56 or 56, 52 are spaced apart at a second distance D2, where the second distance D2 is greater than the first distance D1. As shown in FIGS. 8 and 9, D1 may be essentially zero, e.g. infinitesimally small, when the joined segments 52, 54, 56 are initially very close together. The first and second distances D1 and D2 extend from the coronal end 48 to the apical end 50 of the anchor 20. The circumference C of the outer form 74, measured at any plane normal to and along the central axis A1, will also expand during transformation from the first, unexpanded position to the second, expanded position.

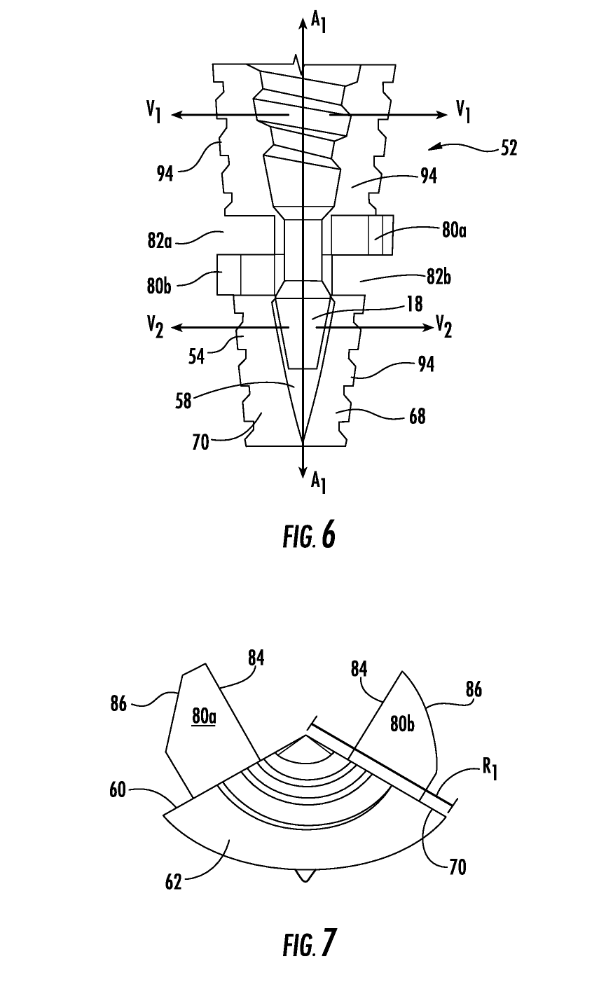

The transformation from the first, unexpanded position to the second, expanded position is triggered by rotation R of the core 18 about the central axis A1 and apical displacement of the core 18 into the inner chamber 58 along the central axis A1. A key aspect of the inventive dental implant 10 is that the core 18 expands the joined segments 52, 54, 56 of the anchor 20 simultaneously at the coronal and apical ends 48, 50 of the anchor 20. This is the result of the first frusto-conical, tapered section 28 at the core coronal end 22 applying an expansion force along force vector V1 (FIG. 6) at the anchor coronal end 52 and the second frusto-conical, tapered section 32 at the core apical end 24 applying an expansion force along force vector V2 at the anchor apical end 54 (FIG. 6). The coronal end 48 and apical end 50 of the anchor 20 are horizontally displaced in parallel paths (in the direction of V1 and V2) away from the central axis A1.

In the embodiment shown in FIGS. 1-11, the anchor consists of a first, second and third individual joined segment 52, 54, 56. Therefore, when the anchor 20 expands to fit the tooth socket 12, the joined segments 52, 54, 56 are moving radially away from the central axis A1 in a plane normal to the central axis A1. Where the anchor 20 consists of only a first and second individual joined segment, the joined segments will displace in a linear, opposing path in a plane normal to the central axis A1 when the core 18 exerts the expansion force and the anchor 20 expands to fit the tooth socket 12.

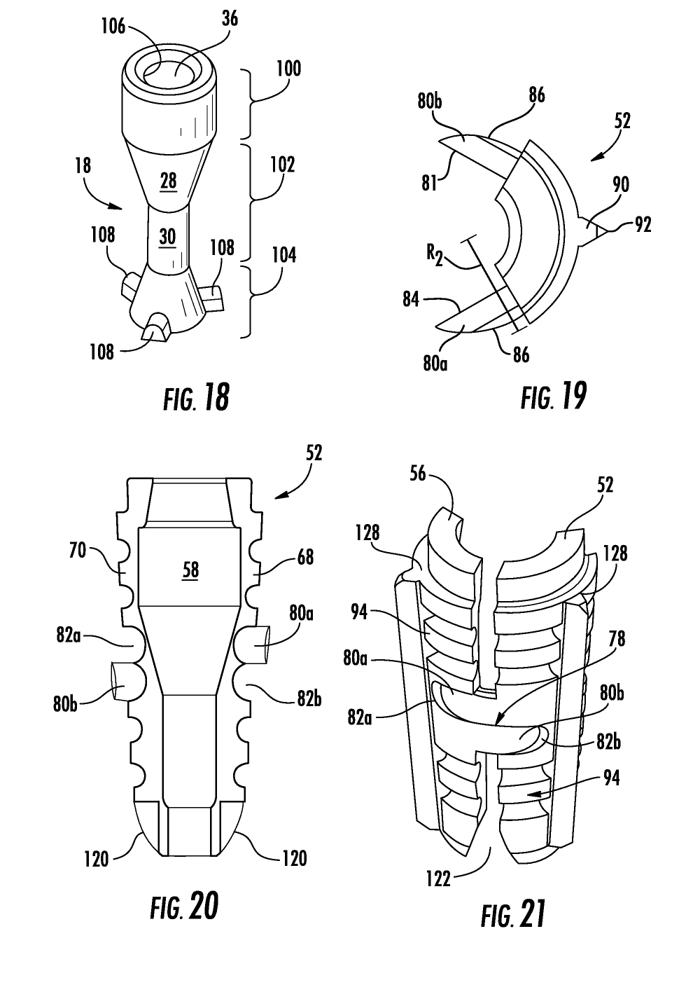

FIGS. 13-24 show another embodiment of the present inventive dental implant 10. The device consists of three primary components: the core 18, expandable anchor 20, and a bolt 98. As shown in detail in FIG. 18, the core 18 consists of a first section 100, an apically adjacent second section 102, and an apically adjacent (to the second section 102) third section 104. The first section 98 is generally cylindrical and includes a receptacle 36 configured to receive the bolt 98. The inner surface of the receptacle 36 may include a helical thread 106 that will threadedly engage a corresponding helical thread 118 on the body portion 112 of the bolt 98.

The second section 102 of the core 18 may consist of one or more frusto-conical sections and one or more non-frusto-conical sections. In the current embodiment, the second section 102 consists of a frusto-conical, tapered section 28 and a cylindrical portion 30 apically adjacent to the tapered portion 28. The third section 104 includes a core rotation restrictor 108 to restrict unwanted and unnecessary rotation of the core during operation of the dental implant 10. As seen in FIG. 13, the core rotation restrictor consists of at least a first lug 108 and preferably a plurality of lugs 108 that extend radially outward from the third section 104. The core rotation restrictor may also consist of a triangular or other non-circular cross-section applied to the third section 104. The plurality of lugs 108 or points/corners of the triangular or non-circular cross-section will be received by notches 122 formed between adjacent joined segment 52, 54 or 54, 56 or 56, 52 when the joined segments are fitted together.

The expandable anchor 20 has a coronal end 48, an apical end 50 and consists of a plurality of individual, joined segments 52, 54, 56 that form an inner chamber 58 configured to receive and envelope the core 18. Each of the plurality of joined segments 52, 54, 56 includes outer and inner surfaces 60, 62, a top surface 64 at the coronal end 48, a bottom 66 at the apical end 50, and opposing side surfaces 68, 70. The top surface and bottom 64, 66 are generally curved or arced in their cross section and configuration and the outer and inner surfaces 60, 62, following the general curvature of the top and bottoms 64, 66, are generally curved or wrapped trapezoidal. In this configuration the segments 52, 54, 56, when joined together, will exhibit an overall taper from the coronal end 48 towards the apical end 50 along the central axis A1 of the dental implant 10. The profile of the joining of the bottom 66 and sides 68, 70 is curved 120 (FIG. 20) creating a notch 122 (FIG. 21) when adjacent joined segments 52, 56 are fitted together. The inner and outer form configurations for the anchor 20 and individual joined segments 52, 56, 56 shown in FIGS. 4A and 4B, as described in detail above, may be adopted for use in the current embodiment of the invention.

The bolt consists of a head portion 110 and a threaded body portion 112. The head portion 110 may have a recess 114 on the top surface that receives a corresponding tool such as an Allen key or a Torx screwdriver bit. Alternatively, the recess 114 may also have hexagonal flats so that it can be rotated with a conventional socket driver. The head portion 110 has an annular flange 116 at its widest diameter to provide a surface for the expandable anchor 20 to expand against during operation of the dental implant 10. The annular flange 116 serves as a “stop” or restrictor against over expansion of the joined segments 52, 54, 56 of the anchor 20. The head portion 110 of the bolt may have a medical taper to allow an abutment component to connect thereto. The body portion 112 is cylindrical in shape with a helical thread 118 that corresponds to the helical thread 106 of the receptacle 26 in the first section 100 of the core 18.

The individual joined segments 52, 54, 56 of the expandable anchor 20 are joined together with connectors 78 in a manner to facilitate expansion of the individual joined segments 52, 54, 56 in a plane that is normal to the central axis A1 during operation of the dental implant 10. As seen in FIGS. 19-21, the joined segments 52 consists of a paired arm 80a, 80b and groove 82a, 82b assembly on each side surface 68, 70. Reference to the joined segment 52 is exemplary and joined segments 54, 56 incorporate the same features and configuration unless specifically noted herein. The arms 80a, 80b extend into and are received by a corresponding groove 82a, 82b on an adjacent joined segment. The joined segments 52, 54, 56 are held in place and guided during expansion of the dental device 10 by these arm 80 and groove 82 assemblies.

The arms 80a, 80b provide for restrictive movement of the adjacent joined segments 52, 54 or 54, 56, or 56, 52, thereby enabling the segments to move in one direction only, namely, radially in a plane normal to the central axis A1. The arms 80a, 80b protrude out of the joined segment 52 tangentially to the radius R2 of the inner surface 62 of the joined segment 52. The arms 80a, 80b may be of any shape but the corresponding grooves 82a, 82b have a similar shape to allow for the arms 80a, 80b, The arms 80a, 80b fit tightly into their corresponding grooves 82a, 82b with a friction fit. These segments only move apart when actuated by the core 18 during operation of the dental device, namely by the coronal displacement of the 18 within the inner chamber 58 of the anchor 20.

In the figures associated with this embodiment of the invention, and specifically FIGS. 19-21, the joined segment 52 includes a first and second arm and groove assembly at different heights on the segment and with the arm and groove from each assembly arranged in a staggered configuration, e.g. each side surface 68, 70 including a single arm and a single groove. In the top plan view of FIG. 19, the arms 80a, 80b are wedge shaped with a straight or flat inner profile 84 and generally curved outer profile 86.

The joined segments 52, 54, 56 of the anchor 20 may also be releasably secured together via a hole-and-pin mechanism (96, 98 in FIGS. 17-18) where a first joined segment has a pin that is received by a hole or receptacle on the adjacent joined segment and where each joined segment has at least one pin and one hole. The joined segments 52, 54, 56 may be held together via a connector 78 consisting of a laser welded titanium wire that is attached to a first joined segment and passes through a corresponding receptacle in the adjacent joined segment or by a biodegradable stretchable suture or an elastic band.

The outer surfaces 60 of each of the joined segments 52, 54, 56 of the anchor 20 may also include a rotational restrictor device consisting of an outwardly extending, vertical blade 90. The blade 90 extends over the majority of the length of each joined segment 52, 54, or 56 and consists of an acute-angled cutting edge 92 for securing the dental implant 10 in the tooth socket 12 against rotation about the central axis 12.

The outer surfaces 60 of each of the joined segments 52, 54, 56 of the anchor 20 may also include a rotational restrictor device consisting of an outwardly extending, vertical blade 90. The blade 90 extends over the majority of the length of each joined segment 52, 54, or 56 and consists of an acute-angled cutting edge 92 for securing the dental implant 10 in the tooth socket 12 against rotation about the central axis 12. The outer surface 60 of a joined segment 52, 54, or 56 of the anchor 20 may also include a vertical displacement restrictor consisting of at least a first horizontal ridge 94 that is substantially perpendicular to the blade 90 and extends across the width of the outer surface 60 of a joined segment. In the embodiments shown herein, the vertical displacement restrictor consists of a plurality of horizontal ridges 94.

The plurality of horizontal ridges 94 protrude outwardly from the outer surface 60 but have a depth that is less than the depth of the blade 90. Thus, the vertical blades 90 on the joined segments 52, 54, or 56 of the anchor 20 will engage the tooth socket 12 first to restrict rotational movement of the dental implant 10 during the initial insertion and placement within the tooth socket 12. As the anchor 20 expands during operation of the dental implant 10, the ridges 94 on the joined segments 52, 54, or 56 of the anchor 20 will subsequently engage the tooth socket 12 to restrict vertical displacement of the implant 10 within the tooth socket 12. A plurality of bone in-growth holes or bores 96 is disposed on the outer surface 60 of the joined segments 52, 54, or 56 and extends through each joined segment to the inner surfaces 62. The arrangement of the blades 90, ridges 94, and bone in-growth holes 96 on each of the joined segments allows for better osseointegration of bone as they provide a path for bone growth.

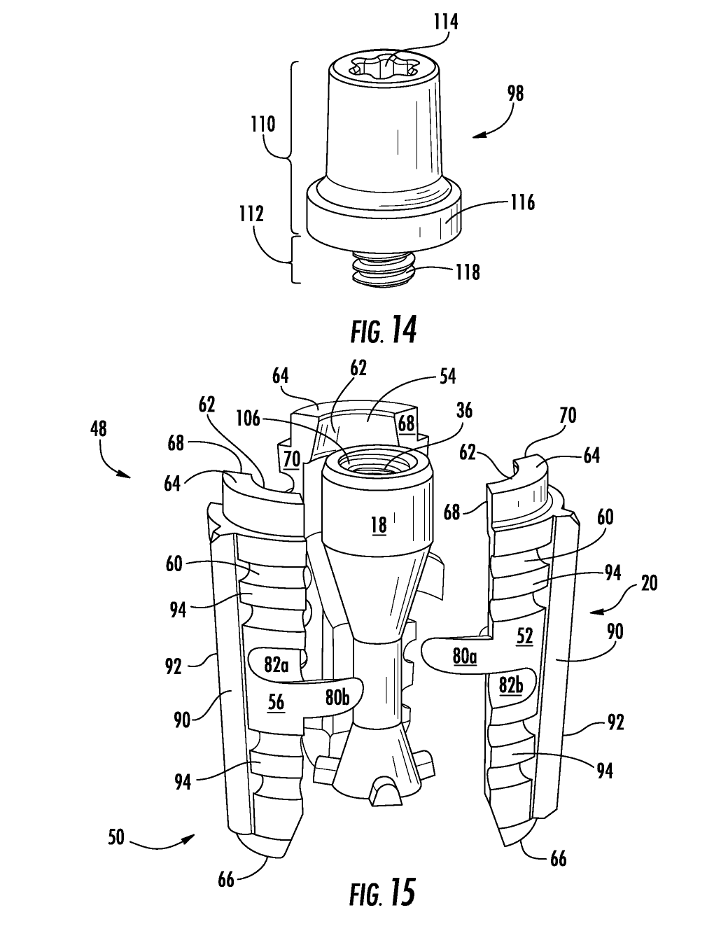

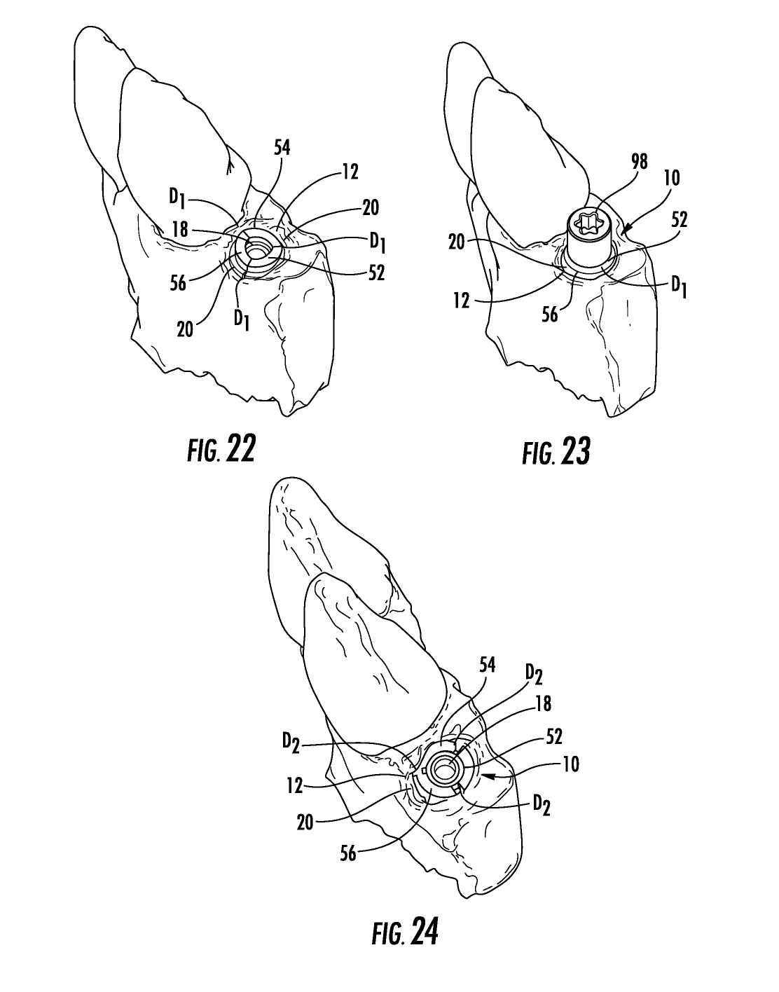

FIGS. 16 and 17 show the present inventive dental implant 10 in a first, unexpanded position (FIG. 16) and a second, expanded position (FIG. 17) the transition resulting from the core 18 being displaced within the inner chamber 58 of the anchor 20 and generating an expansion force applied to joined segments 52, 54, 56 of the anchor 20. FIGS. 22 and 24 show the core 18 and anchor 20 in the unexpanded and expanded positions without the bolt 98 attached thereto. The anchor 20 fits over and envelops the core 18. As seen in FIG. 16, the coronal end of the core 18 (the first section 100) is recessed within the inner chamber 58 of the anchor 20. The bolt 98 is fitted to the assembled anchor 20 and core 18 such that the annular flange 116 of the bolt head portion 110 fits over the coronal portions 120 of the joined segments leaving a first gap 124 between the inner wall of the annular flange 116 and coronal portions 120 of the joined segments.

A second gap 126 is formed by the recessed positioning of the core 18 in the inner chamber 58 and between the coronal portions 120 of the joined segments and the threaded extension 118 of the bolt body portion 112. The third segment 104 of the core 18 protrudes from the apical end 50 of the anchor 20. The bottom of the annular flange 116 sits on the lip 128 of the anchor 20. The threaded extension 118 of the bolt body portion 112 is threaded into the receptacle 26 in the first section 100 of the core 18 and the helical thread 106 of the first section 100 mates with the helical thread of the threaded extension 118.

Rotation of the bolt 98 about the central axis A1 will further thread the threaded extension 118 of the bolt 98 into the threaded receptacle 36 of the core 18 and displaces the core 18 coronally. The core 18 is restricted from rotating by the plurality of lugs 108 of the core rotation restrictor being received by the notches 122 formed between adjacent joined segments when fitted together to form the anchor 20. The process of threading the bolt 98 into core 26, drawing the core 26 coronally, generates the expansion force and transforms the anchor 20 from its first, expanded position to its second, expanded position (FIGS. 17 and 24). The flange 116 and anchor 20 remain in rigid contact at lip 128 causing the core 18 to be displaced coronally and drawn along the central axis A1 towards the coronal end 14 of the dental implant 10. As shown in FIG. 17, the coronal end of the core first section 100 is drawn into and fills the second gap 126 space and applies the expansion force to the joined segments 52, 54, with the coronal ends 120 of the joined segments filling the first gap 124. Also as seen in FIG. 17, the third section 104 of the core 18 is displaced coronally along the central axis A1 and is fully recessed within the inner chamber 58 of the anchor and the individual elements of the core rotation restrictor 108 are received by the notches 122.

The joined segments 52, 54 are biased outwardly and displaced in a plane normal to the central axis A1 by the expansion force. The presence of connectors 78 (FIG. 21) and namely the arrangement of the arms 80a, 82a and grooves 80b, 82b guide the entire length of the each of the joined segments 52, 54, 56 along the displacement path normal to the central axis A1. In this manner, the coronal and apical ends of the anchor 20 will be displaced in parallel paths normal to the central axis A1 resulting in better positioning of the dental implant 10 in the tooth socket 12. Once the bolt is fully tightened, all the components of the dental implant 10 are locked together and act as a solid object.

The expandable anchor 20 is transformable from a first, unexpanded position (FIGS. 16 and 22) wherein opposing side surfaces 68, 70 of adjacent segments 52, 54 or 54, 56 or 56, 52 are radially spaced apart at a first distance D1 and a second, expanded position (FIGS. 17 and 23) where opposing side surfaces 68, 70 of adjacent segments 52, 54 or 54, 56 or 56, 52 are spaced apart at a second distance D2, where the second distance D2 is greater than the first distance D1. As shown in FIGS. 8 and 9, D1 may be essentially zero, e.g. infinitesimally small, when the joined segments 52, 54, 56 are initially very close together. The first and second distances D1 and D2 extend from the coronal end 48 to the apical end 50 of the anchor 20. The circumference C of the outer form 74, measured at any plane normal to and along the central axis A1, will also expand during transformation from the first, unexpanded position to the second, expanded position.

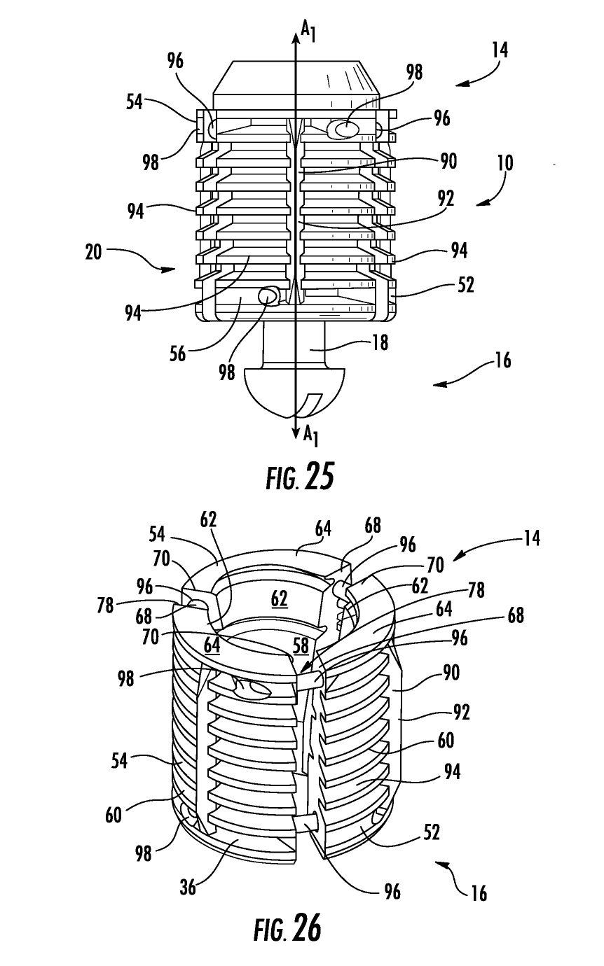

FIGS. 25-26 show another embodiment of the present inventive dental implant 10 where the connector 78 releasably securing adjacent joined segments 52, 54 or 54, 56 or 56, 52 with an aligned pin member 96 on a side surface 68 of one joined segment to be received by a receptacle 98 on a side surface 70 of the adjacent joined segment. The connectors 78 facilitate radial expansion of the individual, joined segments 52, 54, 56 during operation of the dental implant 10. Connectors 78 may be used utilized at both the coronal and apical ends 14, 16 of the anchor 20, as shown in these figures, or utilized at only the coronal end 14 or apical end 16 of the anchor 20.

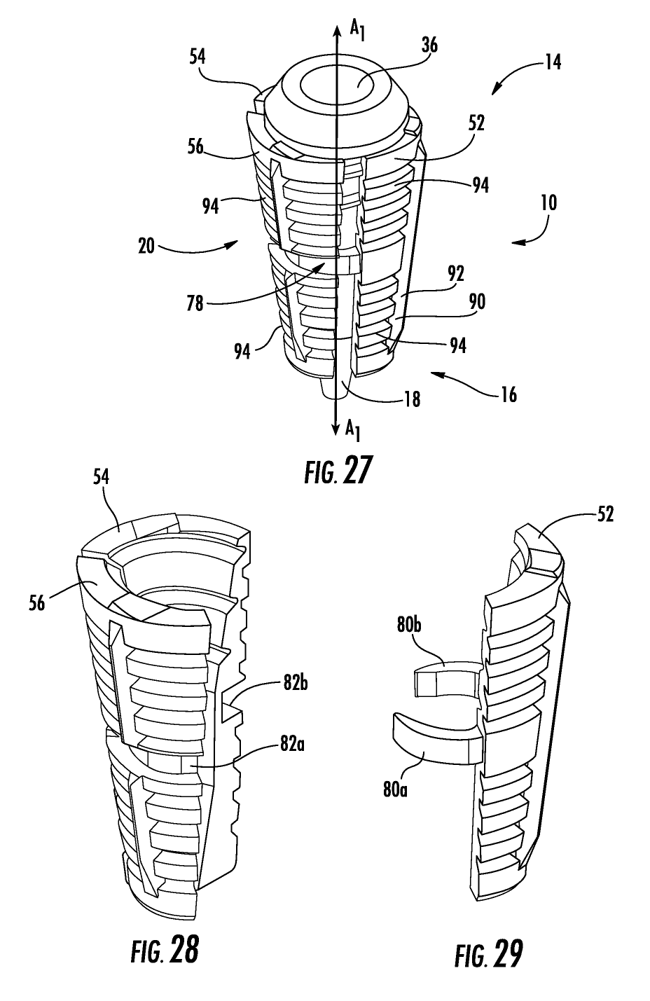

FIGS. 27-29 show another embodiment of the present inventive dental implant 10 where the connector 78 releasably securing adjacent joined segments 52, 54 or 54, 56 or 56, 52 consist of clasps having an arm 80 that fits into a grove 82. In the embodiment seen in these figures, segment 52 includes a first and second arm 80a, 80b with the first arm 80a aligning with and being received by groove 82a on the segment 56 and the second arm 80b aligning with and being received by groove 82b on the segment 54. The grooves 82a, 82b allow for the clasps 80a, 80b to hold the adjacent joined segments 52, 54 or 54, 56 or 56, 52 in place and expand during operation of the dental implant 10. Optionally, the joined segments 52, 54, 56 may all include aligned segments of a groove and the clasp is fabricated separately and fitted during assembly of the dental implant 10.

In operation, the process of threading the core 18 into the radially expandable anchor 20 radially expands the joined segments 51, 52, 54, 56 of the anchor 20 to fit the tooth socket 12 and secure the dental implant 10 in place.

The dental implant 10 disclosed herein generally works such that:
1. The dentist extracts the native tooth and prepares the implant site by removing any septum bone that may interfere with the placement of the device.
2. Using a gauge, the dentist chooses the size of the dental implant required. Alternatively, the manufacturer may supply a set of plastic implant duplicates or trial models. These can be used as templates for a surgical trial run and discarded if they are the wrong size. Once the correct size is determined, the matching implant (or device) can be fitted with confidence.
3. The entire dental implant, in its unexpanded, first position, is placed in the socket. This action will allow the cutting edges of the blades on each of the joined segments of the anchor to grip the walls of the tooth socket and prevents the dental implant from rotating in the next step. It also prevents the dental implant from dropping too deep into the socket.
4. The core (18) or bolt (98), depending on the embodiment, is then rotated using a wrench or similar device and displaced in the anchor. This causes the joined segments of the anchor to radially expand and push against the walls of the tooth socket. This action results in the horizontal ridges of the joined segments to also come into contact with the walls of the tooth socket and drives the cutting edges of the blades into the bone surrounding the tooth socket.
5. The vertical displacement of the core and the resulting expansion of the anchor tightly locks the dental implant into the tooth socket, creating primary stability and thereby allowing osseointegration to occur.
6. The socket is sutured to approximate the surrounding tissues. At a suitable time, a dental prosthesis or healing cap can be placed at the coronal end of the dental implant.
7. The implant site is allowed to heal and is reviewed on a regular basis by the dentist.
8. If the dental implant demonstrates excellent primary stability from the outset, it may be possible to immediately place an abutment and crown restoration.

While the present invention has been described in connection with a specific application, this application is exemplary in nature and is not intended to be limiting on the possible applications of this invention. It will be understood that modifications and variations may be effected without departing from the spirit and scope of the present invention. It will be appreciated that the present disclosure is intended as an exemplification of the invention and is not intended to limit the invention to the specific embodiments illustrated and described. The disclosure is intended to cover, by the appended claims, all such modifications as fall within the scope of the claims.

1. A dental implant for fitting into a tooth socket after extraction of a native tooth, the dental implant having a coronal end, an apical end, and a central axis extending through the coronal end and the apical end, the dental implant comprising:
a. a core comprising a coronal end and an apical end;
b. an expandable anchor comprising a coronal end, an apical end, and a plurality of adjacent joined segments, each joined segment including a coronal end and an apical end and the plurality of joined segments defining an inner chamber configured to receive the core; and
c. a dental prosthesis receptacle at the dental implant coronal end.
wherein the expandable anchor is transformable from a first, unexpanded position to a second expanded position in response to an expansion force generated by displacement of the core within the inner chamber of the anchor wherein the coronal end and apical end of each of the joined segments of the anchor are displaced away from the central axis in response to the expansion force.

2. The dental implant of claim 1, the core including a body member having a length extending from the core coronal end to the core apical end and along the central axis, a tapered section tapering from the core coronal end towards the core apical end, extending at least a first portion of the length of the core along the central axis.

3. The dental implant of claim 2, the core including and a first helical thread extending at least a portion of the length of the core, and the inner chamber of the anchor including a second helical thread corresponding to the first helical thread of the core to enable threaded engagement of the core and anchor.

4. The dental implant of claim 1 wherein the expansion force is generated by rotation of the core about the central axis and displacement of the core into the inner chamber of the anchor along the central axis.

5. The dental implant of claim 4 wherein the core is apically displaced within the inner chamber along the central axis to generate the expansion force.

6. The dental implant of claim 1 wherein the core is coronally displaced within the inner chamber along the central axis to generate the expansion force.

7. The dental implant of claim 6 further including a bolt with a helical thread, the core further includes a receptacle at the core coronal end having a helical thread that corresponds to the helical thread of the bolt and wherein rotation of the bolt coronally displaces the anchor along the central axis.

8. The dental implant of claim 1 wherein each of the plurality of joined segments taper from the anchor coronal end to the anchor apical end along the central axis.

9. The dental implant of claim 1 wherein the dental prosthesis receptacle is disposed at the core coronal end.

10. The dental implant of claim 1 wherein the body member of the core consists of a first tapered section and a second, cylindrical section that is apically adjacent the tapered section.

11. The dental implant of claim 10 wherein the core body member further includes a second tapered section that is apical to the first tapered section.

12. The dental implant of claim 11 wherein an angle of taper for the first tapered section is equal to an angle of taper for the second tapered section.

13. The dental implant of claim 1 wherein each of the joined segments of the expandable anchor includes an aligned first arm and first groove, wherein an arm and groove of adjacent joined segments releasably engage to secure the adjacent joined segments together.

14. The dental implant of claim 1 wherein each of the joined segments includes an outer surface extending between the top surface and bottom of each joined segment and the outer surfaces of the joined segments, when fitted together, taper along the central axis towards the apical end of the implant.

15. The dental implant of claim 1 wherein each of the joined segments includes an outer surface extending between the top surface and bottom of each joined segment and the outer surfaces of the joined segments, when fitted together, extend parallel to the central axis.

16. The dental implant of claim 1 wherein the displacement of the core within the inner chamber along the central axis within the inner core generates and transfers the expansion force from the core to the joined segments of the expandable anchor at the coronal end of each of the joined segments of the expandable anchor along a force vector normal to the central axis.

17. The dental implant of claim 16 wherein the displacement of the core within the inner chamber along the central axis transfers the expansion force from the core to the apical ends of each of the joined segments of the expandable anchor along a force vector normal to the central axis.

18. The dental implant of claim 1 further consisting of a stop member at the core apical end, the stop member being dimensioned to restrict coronal displacement of the stop member along the central axis into the inner chamber of the expandable anchor.

19. The dental implant of claim 18 wherein the stop member consists of a hemispherical ball.

20. The dental implant of claim 1 further consisting of circumferential lip at the core coronal end, the circumferential lip dimensioned to restrict apical displacement of the core coronal end along the central axis into the inner chamber of the expandable anchor.

21. The dental implant of claim 1 wherein the anchor consists of an outer form having an asymmetric circumference.

22. The dental implant of claim 21 wherein the inner chamber of the anchor consists of a circular inner form and the outer form and inner form are eccentric.

23. The dental implant of claim 1 further comprising a rotational movement restrictor.

24. The dental implant of claim 23 wherein the rotational movement restrictor consists of a vertical blade on the outer surface of at least a first of the plurality of joined segments.

25. The dental implant of claim 24 wherein the rotational movement restrictor has a first depth and the dental implant further includes a vertical displacement restrictor having a second depth and wherein the first depth is greater than the second depth.

26. The dental implant of claim 25 wherein the vertical displacement restrictor consists of a ridge.

27. The dental implant of claim 1 further consisting of a vertical displacement restrictor.

28. The dental implant of claim 27 wherein the vertical displacement restrictor consists of a ridge on at least a first of the joined segments of the anchor.

29. The dental implant of claim 1 wherein each joined section of the expandable anchor includes a pin member configured to be received by a receptacle disposed in an adjacent section.

30. The dental implant of claim 1 further consisting of a plurality of holes extending through the width of each of the plurality of segments of the expandable anchor.

31. The dental implant of claim 1 further consisting of a threaded bolt and the core coronal end includes a thread corresponding to the thread of the threaded bolt to threadedly engage the bolt and the core.

32. The dental implant of claim 31 wherein rotation of the bolt about the central axis coronally displaces the core within the inner chamber of the expandable anchor.

33. The dental implant of claim 32 where a core rotation restrictor restricts rotation of the core as the bolt rotates about the central axis.

34. The dental implant of claim 33 wherein the core rotation restrictor consists of a first lug on the core extending radially outward from the central axis and the first lug is received by a notched formed between adjacent joined segments when the plurality of joined segments is fitted together.

35. A dental implant for fitting into a tooth socket after extraction of a native tooth having a coronal end, an apical end, and a central axis extending from the coronal end to the apical end, the dental implant comprising:
a. a core comprising a coronal end, an apical end, and a body member having a tapered section tapering from the core coronal end towards the core apical end, and a first helical thread on the tapered section, and;
b. an expandable anchor comprising a coronal end and apical end, a plurality of joined segments defining an inner chamber and outer form, each of the plurality of segments, having a top surface at the coronal end, bottom at the apical end, and side surfaces extending between the anchor coronal end and anchor apical end, the inner chamber configured to receive at least a first portion of the core body member and including a second helical thread corresponding to the first helical thread of the core enabling threaded engagement of the core and anchor;
wherein the expandable anchor is transformable from a first, unexpanded position to a second, expanded position in response to an expansion force generated by rotation of the core about the central axis, threading of the core and anchor, and apical displacement of the core within the inner chamber and wherein the expansion force is transferred from the tapered section of the core to the expandable anchor and the coronal end and apical end of each of the joined segments of the anchor are displaced away from the central axis in response to the expansion force.

36. The dental implant of claim 35 wherein the outer form has an asymmetric circumference.

37. The dental implant of claim 35 wherein each of the joined segments includes an outer surface extending between the top surface and bottom of each joined segment and the outer surfaces of the joined segments, when fitted together, taper along the central axis towards the apical end of the implant.

38. The dental implant of claim 35 further including a vertical blade on the outer surface of at least a first of the plurality of joined segments.

39. The dental implant of claim 35 further including a plurality of horizontal ridges on the outer surface of at least a first of the plurality of joined segments.

40. The dental implant of claim 39 further including a vertical blade on the outer surface of at least a first of the plurality of joined segments, the vertical blade having a first depth and plurality of horizontal ridges having a second depth wherein the first depth is greater than the second depth.

41. A dental implant for fitting into a tooth socket after extraction of a native tooth having a coronal end, an apical end, and a central axis extending from the coronal end to the apical end, the dental implant comprising:
a. a core comprising a coronal end, an apical end, and a body member having a first and second tapered section, the second tapered section apical to the first section tapered section, each tapering from the core coronal end towards the core apical end; and
b. an expandable anchor comprising a coronal end and apical end, a plurality of joined segments defining an inner chamber and outer form, each of the plurality of segments, having a top surface at the coronal end, bottom at the apical end, and side surfaces extending between the expandable anchor coronal end and anchor apical end, the inner chamber configured to receive at least a first portion of the core body member;
wherein the expandable anchor is transformable from a first, unexpanded position to a second, expanded position in response to an expansion force generated by coronal displacement of the core within the inner chamber along the central axis and wherein the expansion force is transferred from the first tapered section of the core to the expandable anchor coronal end and from the second tapered section of the core to the expandable anchor apical end and wherein the coronal end and apical end of each of the joined segments of the anchor are displaced away from the central axis in response to the expansion force.

42. The dental implant of claim 41 further consisting a bolt including a threaded end configured to be received by a threaded receptacle at the coronal end of the core to threadedly engage the bolt and core and wherein rotation of the bolt about the first axis coronally displaces the core within the inner chamber along the first axis.

43. The dental implant of claim 41 wherein the outer form has an asymmetric circumference.

44. The dental implant of claim 41 wherein each of the joined segments includes an outer surface extending between the top surface and bottom of each joined segment and the outer surfaces of the joined segments, when fitted together, taper along the central axis towards the apical end of the implant.

45. The dental implant of claim 41 further including a vertical blade on the outer surface of at least a first of the plurality of joined segments.

46. The dental implant of claim 41 further including a plurality of horizontal ridges on the outer surface of at least a first of the plurality of joined segments.

47. The dental implant of claim 46 further including a vertical blade on the outer surface of at least a first of the plurality of joined segments, the vertical blade having a first depth and plurality of horizontal ridges having a second depth wherein the first depth is greater than the second depth.

48. The dental implant of claim 1, wherein the dental prosthesis is closed except at an opening at the dental prosthesis coronal end, whereby the dental prosthesis receptacle is completely separated from the inner chamber of the expandable anchor precluding communication between the dental prosthesis receptacle and inner chamber of the expandable anchor.

49. The dental implant of claim 1 wherein the expandable anchor is transformable from a first, unexpanded position to a second expanded position in response to an expansion force generated by displacement of the core within the inner chamber of the anchor wherein the coronal end and apical end of each of the joined segments of the anchor are displaced the central axis in response to the expansion force.

50. The dental implant of claim 35 further comprising a dental prosthesis receptacle at the dental implant coronal end wherein the dental prosthesis receptacle is closed except at an opening at the dental prosthesis coronal end, whereby the dental prosthesis receptacle is completely separated from the inner chamber of the expandable anchor precluding communication between the dental prosthesis receptacle and inner chamber of the expandable anchor.

51. The dental implant of claim 50 wherein the dental prosthesis receptacle is disposed at the core coronal end.

52. The dental implant of claim 35 wherein the expandable anchor is transformable from a first, unexpanded position to a second, expanded position in response to an expansion force generated by rotation of the core about the central axis, threading of the core and anchor, and apical displacement of the core within the inner chamber and wherein the expansion force is transferred from the tapered section of the core to the expandable anchor and the coronal end and apical end of each of the joined segments of the anchor are displaced in parallel, linear paths normal to the central axis in response to the expansion force.

53. The dental implant of claim 41, further comprising a dental prosthesis receptacle at the dental implant coronal end wherein the dental prosthesis receptacle is closed except at an opening at the dental prosthesis coronal end, whereby the dental prosthesis receptacle is completely separated from the inner chamber of the expandable anchor precluding communication between the dental prosthesis receptacle and inner chamber of the expandable anchor.

54. The dental implant of claim 53 wherein the dental prosthesis receptacle is disposed at the core coronal end.

55. The dental implant of claim 41 wherein the expandable anchor is transformable from a first, unexpanded position to a second, expanded position in response to an expansion force generated by rotation of the core about the central axis, threading of the core and anchor, and apical displacement of the core within the inner chamber and wherein the expansion force is transferred from the tapered section of the core to the expandable anchor and the coronal end and apical end of each of the joined segments of the anchor are displaced in parallel, linear paths normal to the central axis in response to the expansion force.
